(19) United States
(12) Patent Application Publication
(10) Pub. No.: US 2022/0307695 A1
(43) Pub. Date: Sep. 29, 2022

(54) METHOD FOR CONTROLLING A COOKING APPLIANCE

(71) Applicant: ELECTROLUX APPLIANCES AKTIEBOLAG, Stockholm (SE)

(72) Inventors: Fabio ANGELI, Forli (IT); Filippo MARTINI, Forli (IT); Massimo NOSTRO, Forli (IT); Alex VIROLI, Forli (IT)

(21) Appl. No.: 17/615,634

(22) PCT Filed: Jun. 2, 2020
(86) PCT No.: PCT/EP2020/065147

§ 371 Date: Dec. 1, 2021

(30) Foreign Application Priority Data
Jun. 6, 2019 (EP) 19178892.6

(51) Int. Cl. F24C 7/08; H05B 6/06

(52) U.S. Cl. CPC F24C 7/083; H05B 6/062; H05B 2213/07

(57) ABSTRACT

The invention relates to a method for controlling a cooking appliance (1) with a temperature sensor (5), the cooking appliance (1) comprising at least one heating power transferring element (2) for heating a cookware item (3) placed on a cooking support (4), the method comprising the steps of: —Gathering temperature information related to the cookware item (3) or its content with the temperature sensor (5) at or in the cookware item (3), —after a heat-up process, gathering information regarding a power reduction action initiated by a user input; —evaluating temperature information provided by the temperature sensor (5), said temperature information being correlated with the temperature of the cookware item (3) or the cookware content; —providing temperature lock information to the user if the variation of the temperature of the cookware item (3) or the cookware content is within a certain temperature variation range; —after providing temperature lock information, receiving temperature lock confirmation from the user; —after receiving temperature lock confirmation, controlling the provision of heat energy to the cookware item (3) or the cookware content based on temperature information provided by the temperature sensor (5) such that the temperature of the cookware item (3) is maintained within a given temperature range.

The present invention relates generally to the field of cooking appliances. More specifically, the present invention relates to a method for controlling a cooking appliance which provides automatic temperature control without user interaction.

### BACKGROUND OF THE INVENTION

Cooking appliances, specifically cooking appliances based on induction technology are known in prior art.

In known cooking appliances, the user has to change the power settings manually in order to maintain a constant or essentially constant temperature of the cookware item, which may be, for example a pan or a pot.

Disadvantageously, such manual temperature control is imprecise and time-consuming.

### SUMMARY OF THE INVENTION

It is an objective of the embodiments of the invention to provide a method for controlling a cooking appliance which allows a more precise and user-friendly temperature control. The objective is solved by the features of the independent claims. Preferred embodiments are given in the dependent claims. If not explicitly indicated otherwise, embodiments of the invention can be freely combined with each other.

It is known in the art that household cooking hobs or cooking appliances usually are provided for conducting at least one cooking process comprising heating and/or cooling step, respectively. Such cooking process preferably at least comprises a heating step, e.g. frying, boiling, simmering or pouching of a foodstuff or a cooking liquid, respectively. For supporting the foodstuff or cookware item, it is particularly known to provide a cooking support, for example in the form of a cooking surface. Such cooking surface usually provides a support for the cookware items, for example, provided in the form of a plate element, particularly a glass or glass ceramic plate.

Preferably, the cooking hob comprises, preferably consists of, a cooking support and a lower casing. Thereby it is preferred that an open top side of the lower casing is covered by at least a part of the cooking support. The cooking support may be provided particularly as at least one panel, wherein preferably the panel is a glass ceramic panel. Preferably, at least one or more heating power transferring elements are arranged beneath the panel.

The lower casing may be manufactured from different material comprising plastics or metal, e.g. aluminum.

In particular, such casing may include a bottom wall and at least one sidewall. It is preferred that said casing is made of metal, e.g. aluminium or steel, and/or plastics, wherein preferably the casing made of metal is grounded.

Advantageously said lower casing may comprise at least one heating power energy unit, particularly arranged in a respective heating power energy unit housing, the heating power transferring elements, heating power transferring element carrier or heating power transferring element support. In other words, the lower casing and the cooking support may form a closed unit comprising all essential parts of the cooking hob. Thereby the lower casing may comprise fastening means for fastening and/or arranging the cooking hob on top of or in a cutout of a work plate.

Thereby, preferably, a power transferring element may be arranged below a cooking support. Preferably, the one or more heating power transferring elements are arranged in an upper portion of the lower casing of the cooking hob. A power transferring element may be arranged and supported by one or more heating power transferring element carrier or heating power transferring element support, preferably the power transferring element attached and/or arranged on said carrier or support. A housing comprising an energy power unit may be arranged below one or more heating power transferring element carrier or heating power transferring element supports. Thereby, preferably a heating power transferring element carrier or heating power transferring element support with the supported heating power-transferring element may advantageously be arranged on top of and/or attached to such housing of an energy power unit.

For conducting the cooking process, particularly a heating step, a cooking appliance, particularly the lower casing, comprises at least one heating power-transferring element. Said heating power-transferring element is provided for transferring heating power to the foodstuff or cooking liquid, preferably contained in a cookware item.

Preferably, the at least one heating power transferring element is an electric heating element, in particular an induction heating element, particularly induction coil, and/or radiant heating element. The heating power provided by a heating power-transferring element may be preferably provided electrically. Preferably, the heating power may be provided by a heat-generating magnetic field, more particularly an induction field. Accordingly, the cooking hob of the present invention preferably is an induction hob.

Preferably, a heating power-transferring element in the form of an induction coil comprises a planar conductive winding wire, particularly a copper wire. Preferably, an induction coil comprises at least one magnetic field supporting element, e.g. a ferrite element. Preferably, said at least one magnetic field supporting element, particularly at least one ferrite element, is arranged below the plane of the conductive winding wire. Said at least one magnetic field supporting element, particularly ferrite element, is advantageous in establishing and/or supporting the high frequent alternating magnetic field of the induction coil. Said magnetic field supporting element, particularly if arranged below the conductive winding wire, may be glued to or supported by ferrite support elements, e.g. snap fit connectors or the like.

Preferably, an induction coil comprises a shielding element, e.g. a mica sheet. The shielding element preferably is adapted to the form of the planar conductive winding wire or the form of at least two planar conductive winding wires of at least two adjacently arranged coils. The shielding element preferably is provided above the at least one magnetic field supporting element, particularly at least one ferrite element. The shielding element preferably in its main function is a support for the planar conductive wire windings of the coil. However, additionally the shielding element, particularly mica sheet, may also shield temperature radiated from the above, e.g. resulting from a heated up pot bottom.

In the cooking hob of the present invention the at least one heating power transferring element is preferably arranged and/or mounted on a heating power transferring element carrier or heating power transferring element support, particularly comprised in the lower casing. It is particularly preferred that a carrier made of aluminum sheet metal supports the heating power-transferring element. Particularly, the cooking hob of the present invention may comprise power transferring element carrier or heating power transferring element support to support one heating power transferring element, however, it is also considered herein that one power transferring element carrier or heating power transferring element support is provided to support more than one heating power transferring element.

In a preferred embodiment of the present invention, two heating power transferring elements are arranged on and supported by one common heating power transferring element carrier. Particularly at least two induction coils are arranged on and supported by one common induction coil carrier plate.

The heating power transferring element carrier or heating power transferring element support may be advantageously supported by or on a housing of the heating energy power unit.

Particularly, at least one of, preferably all of, the heating power transferring elements of an cooking hob of the invention, more particularly an induction coil of an induction hob, may be arranged below a cooking support, particularly a cooking surface in form of a plate element, and particularly within the lower casing, in order to provide the heat for a heating step to a heating zone of the cooking support and to the bottom side of a cookware item and foodstuff, respectively, when placed on said heating zone.

A cooking support of a cooking hob of the invention, particularly of an induction hob of the invention, preferably comprises at least one heating zone. Such heating zone as referred to herein, preferably refers to a portion of the cooking support, particularly cooking surface, which is associated with one heating power transferring element, e.g. a radiant heating element or an induction coil, which is arranged at, preferably below, the cooking support, e.g. the glass ceramic plate. Particularly, in an embodiment according to which the cooking hob of the present invention is an induction hob, it is preferred that such heating zone refers to a portion of the cooking support, which is associated with at least one induction coil. Thereby, the heating power transferring elements associated with a heating zone are preferably configured such that the same heating power of the associated heating power transferring elements is transferred to the heating zone. Preferably, the heating zone thus refers to a portion of the cooking support to which the same heating power of the associated at least one heating power transferring element is transferred.

In addition, the cooking hob of the present invention, may particularly be configured such that in one operation mode one or more than one heating zones form one cooking zone and/or are combined to one cooking zone, respectively. A cooking zone may be particularly provided as at least a portion of the cooking surface. Particularly, such cooking zone is associated with at least one heating zone. Additionally, or alternatively, a cooking zone may be associated with more than one heating zone. Particularly, a cooking zone may be associated with an even number, particularly two, four, six, eight or ten, more particularly two, heating zones. Alternatively, a cooking zone may be associated with an uneven number, particularly three, five, seven or nine, more particularly three, heating zones.

Preferably, the cooking hob of the present invention is configured such that a cooking zone comprises one or more than one heating zones, which can be driven with the same or different power, frequency or heating level.

In the present invention, it is preferred that in at least one operation mode of the cooking hob according to the present invention is configured such that a cooking zone comprises at least two, preferably two, heating zones, driven by the same power, frequency or heating level. Particularly, such cooking zone comprises or is associated with at least two, preferably two, heating power-transferring elements.

Additionally, or alternatively, the cooking hob of the present invention may be configured such that the number of heating zones associated with one cooking zone may vary and/or may be adjustable dependent on the needs of the cook and/or the size, form or kind of cookware placed on the cooking surface.

Particularly, a cooking hob according to the present invention, preferably an electric hob, such as an induction hob, may comprise at least one heating power energy unit. A heating power energy unit as used herein, preferably provides energy to at least one of, preferable a number of, the heating power transferring elements such that the heating power transferring element is capable of transferring heating power for heating up the foodstuff or cooking liquid. A heating power energy unit of an induction hob, for example, may provide energy in the form of a high frequency alternating current to a heating power-transferring element in the form of an induction coil, which transfers heating power in the form of a magnetic field to a suitable cookware item. For such purpose, a heating power energy unit may comprise at least one associated power circuit mounted and/or arranged on at least one printed circuit board. Preferably, a heating power energy unit is supported and arranged in a housing, preferably a plastic housing, preferably arrangeable in and adapted to the lower casing. This allows easy manufacturing and modularization.

Particularly, the housing may comprise supporting elements for supporting the heating power transferring element carrier or heating power transferring element support. Particularly, such supporting elements may comprise elastic means, e.g. springs or silicon elements, for elastically supporting the heating power transferring element carrier or heating power transferring element support, and particularly advantageous in pressing a heating power-transferring element onto the bottom surface of the cooking support plate, which particularly is a glass ceramic plate.

Particularly, the heating power energy unit, and particularly the associated power circuit, may be configured to be connected to at least one, preferably two phases of a mains supply. A cooking hob according to the present invention thereby comprises at least one, preferably two or three heating power energy units, connected to one or two, preferably one phases of the mains supply each.

Preferably, a heating power energy unit may comprise at least —one associated power circuit, particularly in the form of an at least one heating power generator, for generating heating power and supplying heating power-transferring elements with heating power, particularly for providing heating power to the at least one heating zone. Thereby the power circuit particularly may be provided in the form of a half-bridge configuration or a quasi-resonant configuration.

It will be immediately understood that the heating power energy unit may thus comprise one heating power generator for providing heating power to more than one heating zone, each associated with at least one heating power transferring element.

Furthermore, the heating power energy unit may comprise one heating power generator comprising a single or pair of high frequency switching elements, in the following also referred to as power transistor.

In particular, the high frequency switching element is provided in the form of a semiconductor-switching element, particularly an IGBT element.

In case the heating power energy unit may comprise one heating power generator comprising a single high frequency switching element, the single switching element preferably forms part of associated power circuit, provided in the form of a or a part of a Quasi Resonant circuit.

In case that the heating power energy unit may comprise one heating generator comprises a pair of high frequency switching elements, said pair of high frequency switching elements preferably forms part of an associated power circuit, provided in the form of a or a part of a half-bridge circuit.

A person skilled in the art will immediately understand that the heat, generated by and/or radiated from particularly the heating power transferring elements, the heating power energy unit and/or the cookware item, particularly the bottom thereof, may have also disadvantageous effects, particularly regarding safety and proper functioning. Particularly, the heating power energy unit, more particularly power circuits comprising switching elements, may generate a significant amount of heat being disadvantage for the safety and proper functioning of the cooking hob. For this reason, the cooking hob comprises at least one cooling means. Particularly, said cooling means is adapted for cooling down the electric and/or electronic elements. Particularly, the heating power energy unit may comprise such cooling means. Such cooling means may comprise at least one of a fan, a cooling channel, a cooling body, preferably from a metal, particularly aluminium, cooling air-guiding means, cooling air deflection means and the like. Particularly, the cooking hob of the present invention may comprise such cooling means for cooling at least one heating power generator or a part thereof, particularly to at least one single or pair of high frequency switching elements. More particularly, such cooling means may comprise a cooling body, preferably arranged in the air path of a cooling fan, and thermally connected to at least one heating power generator or a part thereof, particularly to at least one single or pair of high frequency switching elements. Thereby it is preferred that the cooling means comprises at least one fan for generating an air stream through the cooling channel. Preferably, the cooling channel and/or cooling body extends horizontally through the cooking hob. For example, the cooling channel and/or cooling body extends over a substantial part of the horizontal width of the cooking hob.

The cooking hob according to the present invention preferably further comprises a control unit. Such control unit is preferably operatively connected with the heating power energy unit to control at least one operational parameter of the cooking hob, particularly an operational parameter of the heating power energy unit. Furthermore, the control unit comprises a user interface at least for receiving a command input of a user. This advantageously allows the user to control at least one operational parameter of the cooking hob, particularly an operational parameter of the heating power energy unit. Moreover, the control unit, and particularly a user interface if present, may be operatively connected to other appliances or interfaces, e.g. a suction hood, a voice control device, a server, a remote interface, a cloud-computing source or the like.

Accordingly, the household cooking hob according to the present invention comprises at least one electric and/or electronic element. Particularly, said at least one electric and/or electronic element comprises a heating power energy unit and/or control unit or parts thereof.

Particularly, the at least one electric and/or electronic element of the household cooking hob of the present invention may be part of an at least one heating energy power unit, preferably mounted and/or arranged on a power board and/or a power generating circuit mounted on a printed circuit board (PCB).

Such at least one electric and/or electronic element may be, for example, selected from the group comprising a heating power generator, filter coils, EMC filters, rectifier, switching elements, like IGBTs, relays, or the like.

According to an aspect, the invention refers to a method for controlling a cooking appliance with a temperature sensor. The cooking appliance comprises at least one heating power transferring element for heating a cookware item placed on a cooking support.

The method comprises the following steps:

Gathering temperature information related to the cookware item or its content with the temperature sensor at or in the cookware item.

Optionally, after a heat-up process, information regarding a power reduction action initiated by a user input is gathered. In other words, a control unit of the cooking appliance monitors if a user input is received which lowers the heating power, respectively, the provision of power to one or more heating power transferring elements associated with a cooking zone.

Furthermore, temperature information provided by the temperature sensor is evaluated, said temperature information being correlated with the temperature of the cookware item or the cookware item content. The temperature sensor may be a temperature sensor which indirectly measures the temperature of the cookware item. Therefore, temperature information may comprise an offset or delay with respect to the “real” temperature of the cookware item.

Temperature lock information is provided to the user if the variation of the temperature of the cookware item or the cookware item content is equal or lower than a certain temperature variation value. In other words, it is monitored if the temperature variation over time decayed such that the temperature variation in a given period of time is lower than a temperature variation threshold value.

After providing temperature lock information, a temperature lock confirmation is received. Said temperature lock confirmation may be initiated by a user input at a user interface. The temperature hold information may be to an information to hold the current temperature or to adjust the current temperature by a predetermined value, for example lower or increase the temperature by 2° C.

After receiving said temperature lock confirmation, the provision of heat energy to the cookware item is controlled based on temperature information provided by the temperature sensor such that the temperature of the cookware item or the cookware item content is maintained within a given temperature range. Said provision of heat energy to the cookware item is controlled automatically without any manual control of the user.

Said method is advantageous because the temperature of the cooking process can be controlled in a comfortable and user-friendly way.

According to an embodiment, the temperature information at the point of time at which the temperature lock information is received is used as temperature control target value. In other words, the temperature information is determined when temperature lock information is received and the temperature of the cookware item is controlled based on said temperature information. Or in other words the user may choose to hold the current temperature or optimize the temperature by lower or increase the temperature by a predetermined value.

According to an embodiment, the provision of heat energy to the cookware item is controlled such that the temperature information provided by the temperature sensor is kept in a temperature range provided around the temperature control target value. For example, said temperature range may comprise an upper boundary and a lower boundary. Said upper boundary may be, for example, 1-10° C., more specifically 3-7° C., especially 5° C. above and said lower boundary may be, for example, 1-10° C., more specifically 3-7° C., especially 5° C. below said temperature control target value. Thereby, the temperature of the cookware item can be stabilized around the temperature control target value.

According to an embodiment, temperature lock information is visual information provided at a user interface. For example, temperature lock information may be provided by a LED or another light source. Thereby, the user can visually recognize when a constant or essentially constant temperature state of the cookware item is reached.

According to an embodiment, the temperature sensor comprises a resistor changing its resistance value depending on the temperature. Said temperature sensor may indirectly measure the temperature information of the cookware item through the cooking support.

According to an embodiment, the temperature sensor is an NTC-thermistor. Also other temperature measurement means may be possible.

According to an embodiment, temperature information is derived by sampling an electrical value provided by the temperature sensor. More specifically, temperature information may be derived by periodic sampling a voltage value provided at the temperature sensor.

According to an embodiment, the heating procedure is recorded in a recording mode and information regarding the heating procedure is stored in order to reuse said information for a further heating procedure. Information regarding the heating procedure may be the heating level, respectively, the heating power, the duration of using a certain heating level, the total heating duration etc.

According to an embodiment, the cooking appliance is an induction cooking appliance. However, the control method can also be used in other types of cooking appliances.

According to an embodiment, the temperature of the cookware item is estimated with an algorithm using power board parameters, in particular power consumption and/or switching frequency, as input values.

According to a further aspect, the invention relates to a cooking system comprising a temperature sensor and a cooking appliance, the cooking appliance comprising at least one heating power transferring element for heating a cookware item placed on a cooking support and a user interface at least for receiving a command input of a user. The temperature sensor is configured to provide information regarding a temperature correlated with the cookware item or the cookware content. The cooking appliance further comprises:
a control unit configured to gather information regarding a power reduction action initiated by a user input after a heat-up process;
a control unit configured to evaluate temperature information provided by the temperature sensor, said temperature information being correlated with the temperature of the cookware item or the cookware content;
a control unit configured to provide temperature lock information to the user if the variation of the temperature of the cookware item or the cookware content is equal or lower than a certain temperature variation value;
a control unit configured to receive temperature lock confirmation after providing temperature lock information;
a control unit configured to control, after receiving temperature lock confirmation, the provision of heat energy to the cookware item or the cookware content based on temperature information provided by the temperature sensor such that the temperature of the cookware item is maintained within a given temperature range.

The term “control unit”, as mentioned before, may refer to a single control unit which handles all tasks mentioned before or may refer to multiple control units, i.e. said tasks are handled by multiple control units in a shared manner. The control unit is in particular configured to perform the method according to at least one, in particular all, above described embodiments.

The cooking system may comprise a cooking appliance according to the embodiments specified below. In particular, the temperature sensor may be part of the cooking appliance. In an embodiment the temperature sensor is provided below the cooking support.

According to an embodiment of the cooking appliance, a control unit is configured to control the provision of heat energy to the cookware item such that temperature information provided by the temperature sensor is kept in a temperature range provided around a temperature control target value, said temperature control target value being temperature information provided by the temperature sensor at the point of time at which said temperature lock information is receipt.

According to an embodiment of the cooking appliance, the cooking appliance comprises a user interface configured to provide temperature lock information. For example, temperature lock information may be provided by a LED or another light source.

Thereby, the user can visually recognize when a constant or essentially constant temperature state of the cookware item is reached.

According to an embodiment of the cooking appliance, the temperature sensor comprises a resistor with a temperature-dependent resistance value. According to a preferred embodiment, the temperature sensor is an NTC-thermistor.

According to an embodiment of the cooking appliance, the cooking appliance comprises a storage configured to store information regarding a heating procedure in a recording mode. The cooking appliance is further configured to reuse stored information for a further heating procedure. Said reuse may read stored information from the storage and perform a heating procedure according to said information.

According to an embodiment of the cooking system the temperature sensor may be part of a cookware item or configured to be placed into the cookware item.

According to an embodiment of the cooking system, the temperature sensor is a food sensor, in particular wirelessly coupled with the control unit and/or the internet. Known short range communication technics as Bluetooth or SAW (surface acoustic wave) may be used for the coupling.

According to a further embodiment the food sensor may be a food spit or meat probe.

According to an embodiment of the cooking system the temperatures sensor is combined with an algorithm for estimating the cookware temperature. In particular, the algorithm may use control parameters of the appliance, in particular parameters used by the control unit for controlling the temperature of the cookware item, as input. Additionally or alternatively parameters of a power board of the cooking appliance, like power consumption or frequency of the power or switching frequency may be used as input parameters for the algorithm. In particular the control unit may be configured to execute the algorithm and to adapt provision of the heat energy based on an output of the algorithm or to provide the predetermined value.

According to an embodiment of the cooking appliance, the cooking appliance is an induction cooking appliance.

The term “temperature information provided by the temperature sensor, said temperature information being correlated with the temperature of the cookware item” as used in the present disclosure may refer to any thermal coupling between the temperature sensor and the cookware item due to an indirect temperature measurement. Therefore, the temperature information provided by the temperature sensor may follow the temperature of the cookware item with a certain delay and/or with a certain offset.

The term “essentially” or “approximately” as used in the invention means deviations from the exact value by +/−10%, preferably by +/−5% and/or deviations in the form of changes that are insignificant for the function.

### BRIEF DESCRIPTION OF THE DRAWINGS

The various aspects of the invention, including its particular features and advantages, will be readily understood from the following detailed description and the accompanying drawings, in which:

FIG. 1 shows an example top view on a cooking appliance comprising multiple heating zones;

FIG. 2 shows a schematic illustration of a cooking appliance with a cookware item placed on a cooking support; and

FIG. 3 shows a pair of temperature curves wherein a first temperature curve illustrates the temperature profile of the temperature at the cookware over time and the second temperature curve illustrates the temperature profile of the temperature at a temperature sensor over time.

### DETAILED DESCRIPTION OF PREFERRED EMBODIMENTS

The present invention will now be described more fully with reference to the accompanying drawings, in which example embodiments are shown. The embodiments in the figures may relate to preferred embodiments, while all elements and features described in connection with embodiments may be used, as far as appropriate, in combination with any other embodiment and feature as discussed herein, in particular related to any other embodiment discussed further above. However, this invention should not be construed as limited to the embodiments set forth herein. Throughout the following description similar reference numerals have been used to denote similar elements, parts, items or features, when applicable.

The features of the present invention disclosed in the specification, the claims, examples and/or the figures may both separately and in any combination thereof be material for realizing the invention in various forms thereof.

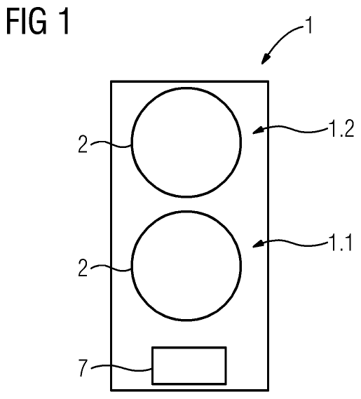

FIG. 1 illustrates a schematic diagram of an electric cooking appliance 1, specifically an induction hob.

The induction hob 1 comprises multiple heating zones 1.1, 1.2. Each heating zone 1.1, 1.2 may be, for example, associated with one or more heating power transferring elements 2, specifically, one or more induction coils. In the present embodiment, each heating zone 1.1, 1.2 is associated with a single heating power transferring element 2. However, according to other embodiments, a heating zone 1.1, 1.2 may be associated with multiple heating power transferring elements 2.

In addition, the cooking appliance 1 comprises a user interface 4, based on which a user may control the cooking appliance 1. For example, based on the user interface 7, the user may control the power level of the heating zones 1.1, 1.2.

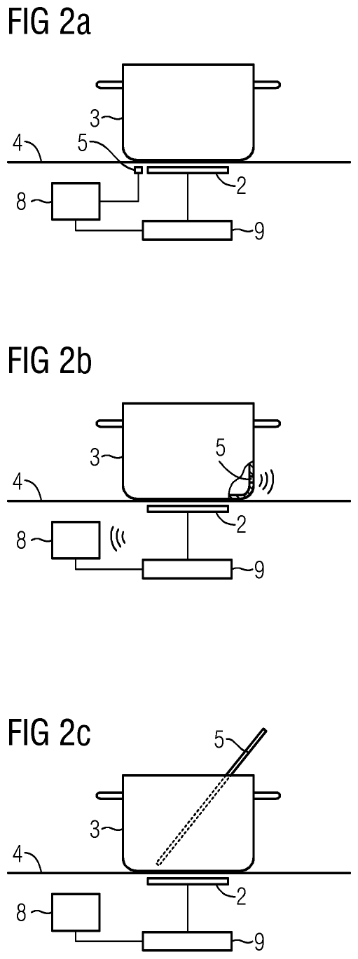

FIG. 2 a-c show schematic side sectional views of a cooking system with a cooking appliance 1 on which a cookware item 3 is placed. The cooking appliance 1 comprises a cooking support 4 on which the cookware item can be placed.

Below the cooking support 4, a heating power transfer element 2 is provided. The heating power transfer element 2 may be, for example, an induction coil. The heating power transfer element 2 is coupled with a heating power energy unit 9.

In order to determine the temperature of the cookware item 3, a temperature sensor 5 is provided either with the appliance or separately. Said temperature sensor 5 may be arranged below the cooking support 4 as shown in FIG. 2a. Thus, the temperature sensor 5 may be adapted to indirectly measure the temperature of the cookware item 3 based on the heat transmitted by the cookware item 3 through the cooking support 4. Alternatively, the temperature sensor 5 may be provided with the cookware item 3 as shown in FIG. 2b or may be a food sensor placeable in the cookware item 3 as shown in FIG. 2c.

The temperature sensor 5 may comprise a thermal resistor, i.e. a resistor which changes the resistance value depending on its temperature. Specifically, the temperature sensor 5 may be an NTC-thermistor (NTC: negative temperature coefficient).

The temperature sensor 5 may be coupled with a control unit 8. This coupling may be a wired coupling or a wireless coupling with a known wireless short range technology. The control unit 8 may be configured to receive temperature information from the temperature sensor 5 and provide temperature control based on said temperature information. The control unit 8 may be a central control unit. The control unit 8 may also be coupled with the heating power energy unit 9 in order to control the provision of heat to the cookware item 3.

In order to support the user of the cooking appliance 1 in keeping the temperature of the cookware item 3 constant or essentially constant, the cooking system and/or cooking appliance 1 is configured to perform a temperature control method.

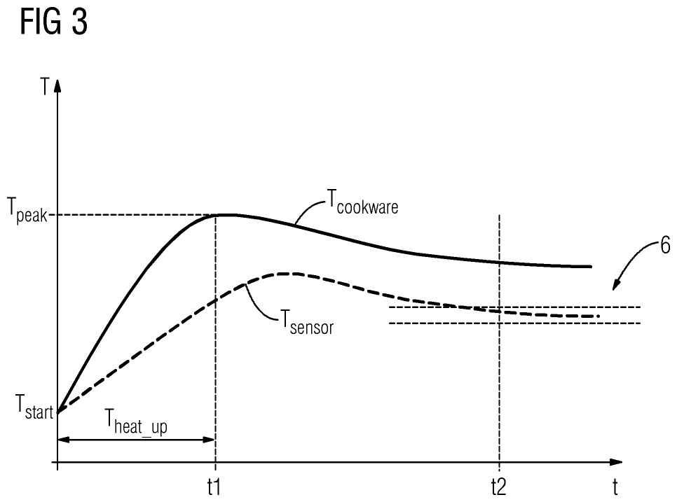

FIG. 3 shows a diagram indicating the temperature of the cookware T_{cookware} over time. In addition, the diagram includes a temperature curve indicating the temperature information Tₛₑₙₛₒᵣ measured by the temperature sensor 5 over time.

The temperature curves regarding T_{cookware} and Tₛₑₙₛₒᵣ refer to a heating procedure, in which a cookware item 3 is heated up in a heat-up phase t_{heat_up}. During said heat-up phase, the temperature of the cookware item 3 may rise from a start temperature Tₛₜₐᵣₜ.

After reaching a certain temperature Tₚₑₐₖ, which may be, for example the boiling temperature, the user may lower the heating power provided to the cookware item 3 (point of time t1). Said lowering of heating power may be performed due to an input of the user at the user interface 7.

Due to said lowering of heating power, the temperature of the cookware T_{cookware} may lower and approximate to a constant temperature value.

As can be seen in FIG. 3, due to the indirect temperature measurement performed by the temperature sensor 5, temperature information Tₛₑₙₛₒᵣ follows the temperature of the cookware T_{cookware} with a certain offset and/or a certain delay. However, also temperature information Tₛₑₙₛₒᵣ approaches to a constant temperature value.

In order to support the user in keeping the temperature of the cookware T_{cookware} constant or essentially constant over time, the control unit 8 may monitor if the heating power is lowered by means of a certain input at the user interface 7.

If such lowering action is recognized, the control unit 8 is configured to monitor the decay of temperature information Tₛₑₙₛₒᵣ. More specifically, the control unit 8 may monitor if the variation of the temperature information Tₛₑₙₛₒᵣ stays within a given temperature variation range. Even more specifically, the control unit 8 may monitor if the variation of the temperature information Tₛₑₙₛₒᵣ stays within the temperature variation range in a certain period of time. Said monitoring may be performed by sampling the electrical signal provided by the temperature sensor 8 and processing said sampled information by the control unit 8.

For example, after recognizing a lowering of heating power by a user input, the control unit 8 may constantly or at certain intervals check if the variation of temperature information Tₛₑₙₛₒᵣ within a certain period of time is equal or lower than a certain temperature variation value. Said temperature variation value may be the difference between an upper and a lower temperature boundary.

If the variation of temperature information Tₛₑₙₛₒᵣ within a certain period of time is equal or lower than a certain temperature variation value (point of time t2), the control unit 8 may provide temperature lock information. Said temperature lock information may be indicative for the user that the cookware temperature has reached a constant or essentially constant value.

The temperature lock information may be visually recognizable information and/or audible information. The temperature lock information may be provided at or via the user interface 7. For example, the temperature lock information may be a light signal provided at the user interface 7.

After the provision of temperature lock information, the user is able to activate a temperature lock mode. Said activation may be performed, for example, by a certain user input. The control unit 8 may receive a temperature lock confirmation. After receiving said temperature lock confirmation, the automatic temperature control may be started.

The control unit 8 may use the present temperature information as a target value for the automatic temperature control. The control unit 8 may control the provision of heating power provided to the heating power transferring element 2 such that the temperature information provided by the temperature sensor 5 is kept within the a given temperature range 6. Said temperature range 6 is schematically illustrated in FIG. 3. Thereby the temperature of the cookware item 3 is kept constant or essentially constant without user interaction.

According to an embodiment, the cooking appliance 1 may be configured to perform a recording mode, in which information regarding the heating procedure is gathered and stored. Thus, the cooking appliance 1 may comprise a storage for storing gathered information. In addition, the cooking appliance 1 may provide, for example, at the user interface 7 a cooking procedure menu, which can be used for defining a certain entry for a certain cooking procedure. An example for such cooking procedure may be, for example, a cooking procedure for boiling pasta in a certain cookware item. So, for example, the user can define a new entry or folder in said cooking procedure menu which is associated with certain cooking procedure information. Said entry or folder can be selected later on in order to reuse stored cooking procedure information for the cooking procedure.

More in detail, the cooking appliance 1 is configured to store a certain cooking procedure. Said storing can be initiated before starting the cooking process. Alternatively, the cooking appliance 1 may be adapted to buffer cooking procedure information during a cooking procedure and storing of said cooking procedure information can be initiated during the cooking procedure or after finishing the cooking procedure.

Said cooking procedure information may, for example, comprise information regarding the heating power provided to the cookware item 3, regarding the period of time in which said heating power is provided to the cookware item 3, changes of heating power, the duration of the heating process etc.

After storing said cooking procedure information, the user is able to reuse cooking procedure information later on for a similar or identical cooking procedure.

It should be noted that the description and drawings merely illustrate the principles of the proposed invention. Those skilled in the art will be able to implement various arrangements that, although not explicitly described or shown herein, embody the principles of the invention.

### LIST OF REFERENCE NUMERALS

1 cooking appliance
1.1 heating zone
1.2 heating zone
2 heating power transferring element
3 cookware item
4 cooking support
5 temperature sensor
6 temperature range
7 user interface
8 control unit
9 heating power energy unit

1. Method for controlling a cooking appliance with a temperature sensor, the cooking appliance comprising at least one heating power transferring element for heating a cookware item placed on a cooking support, the method comprising the steps of:
gathering temperature information related to the cookware item or its content with the temperature sensor at or in the cookware item,
after a heat-up process, gathering information regarding a power reduction action initiated by a user input;
evaluating the temperature information provided by the temperature sensor, said temperature information being correlated with a temperature of the cookware item or the cookware item content;
providing temperature lock information to the user if a variation of the temperature of the cookware item or the cookware content is equal to or lower than a certain temperature variation value;
after providing the temperature lock information, receiving a temperature lock confirmation from the user;
after receiving the temperature lock confirmation, controlling provision of heat energy to the cookware item or the cookware content based on the temperature information provided by the temperature sensor such that the temperature of the cookware item or the cookware item content is maintained within a given temperature range.

2. Method according to claim 1, wherein the temperature information at a point of time at which said temperature lock information is received is used as a temperature control target value, and/or wherein the temperature lock information received from the user may be to hold a current temperature, and/or wherein the temperature lock information received from the user may be to adjust the current temperature by a predetermined adjustment value.

3. Method according to claim 2, wherein the provision of heat energy to the cookware item is controlled such that the temperature information provided by the temperature sensor is kept in a temperature range provided around the temperature control target value.

4. Method according to claim 1, wherein the temperature lock information is visual information provided at a user interface.

5. Method according to claim 1, wherein the temperature sensor comprises a resistor changing its resistance value depending on its temperature.

6. Method according to claim 5, wherein the temperature sensor is an NTC-thermistor.

7. Method according to claim 5, wherein the temperature information is derived by periodic sampling of a voltage value provided at the temperature sensor.

8. Method according to claim 1, wherein a heating procedure of the cooking appliance is recorded in a recording mode and information regarding the heating procedure is stored in order to reuse said information for a further heating procedure.

9. Method according to claim 1, wherein the cooking appliance is an induction cooking appliance.

10. Method according to claim 1, wherein the temperature of the cookware item is estimated with an algorithm using power board parameters, including power consumption and/or switching frequency, as input values.

11. Cooking system comprising a temperature sensor and a cooking appliance, the cooking appliance comprising at least one heating power transferring element for heating a cookware item placed on a cooking support and a user interface at least for receiving a command input of a user, the temperature sensor being configured to provide information regarding a temperature correlated with the cookware item or its content,
the user interface being configured to allow the user to control heating power energy supplied by the at least one heating power transferring element, to provide temperature lock information and to input temperature lock confirmation,
the cooking appliance further comprising:
a control unit configured to perform the method of claim 1.

12. Cooking system according to claim 11, wherein the control unit is configured to control provision of heat energy to the cookware item such that said temperature information provided by the temperature sensor is kept in a temperature range provided around a temperature control target value, said temperature control target value being a temperature value at a point of time at which the temperature lock information is received.

13. (canceled)

14. Cooking system according to claim 11, wherein the temperature sensor comprises an NTC-thermistor.

15. Cooking system according to claim 11, comprising a storage configured to store information regarding a heating procedure of the cooking appliance in a recording mode, the cooking appliance being further configured to reuse stored information for a further heating procedure.

16. Cooking system according to claim 11, the cooking appliance being an induction cooking appliance.

17. Cooking system according to claim 11, wherein the temperature sensor is part of the cooking appliance and is provided below the cooking support, or wherein the temperature sensor is a food sensor wirelessly coupled with the control unit and/or the internet.

18. Cooking system according to claim 11, wherein the temperature sensor is combined with an algorithm for estimating the cookware temperature.

19. Cooking system according to claim 11, wherein the temperature sensor is part of the cookware item or is configured to be placed into the cookware item.

20. A method for controlling a cooking appliance comprising a heating power transferring element adapted to supply heating power for cooking, and a control unit adapted to control the heating power transferring element, the method comprising:
operating the heating power transferring element to heat a cookware during a heating procedure;
receiving sensor temperature values from a temperature sensor during the heating procedure, wherein said sensor temperature values correlate to an actual temperature of the cookware; and
upon the sensor temperature values remaining confined within a predetermined temperature variation range over a predetermined time period, providing temperature lock information to notify a user that the temperature of the cookware, which is correlated to the sensor temperature, has achieved an essentially constant temperature;
wherein after providing the temperature lock information, the user interface is configured to accept a user input to activate a temperature lock mode during which the control unit operates the heating power transferring element to maintain the temperature of the cookware at the essentially constant temperature.

21. The method according to claim 21, further comprising monitoring to detect if a user manually lowers the heating power of the heating power transferring element during the heating procedure, wherein said predetermined time period commences after detecting that a user has manually lowered said heating power;
wherein the temperature sensor is disposed adjacent to the cookware so that said temperature sensor values provide an indirect measure of the actual temperature of the cookware, and that changes in said temperature sensor values are time delayed compared to changes in the actual temperature of said cookware during the heating procedure.

22. The method according to claim 22, wherein the heating procedure is recorded in a storage of said appliance, said control unit recalling control parameters, including user inputs, from said heating procedure and re-executing the same to thereby reproduce a similar cooking function in a future heating procedure.
